(19) United States
(12) Patent Application Publication
(10) Pub. No.: US 2026/0080230 A1
(43) Pub. Date: Mar. 19, 2026

(54) TRAINING-FREE ERROR COMPENSATION FOR A COMPRESSED LARGE LANGUAGE MODEL

(71) Applicant: NVIDIA Corporation, Santa Clara, CA (US)

(72) Inventors: Min-Hung Chen, Zhubei City (TW); Shih-Yang Liu, New Taipei (TW); Pavlo Molchanov, Mountain View, CA (US); Maksim Khadkevich, San Francisco, CA (US); Charbel Sakr, Milpitas, CA (US); Chien-Yi Wang, New Taipei City (TW); Saurav Muralidharan, San Jose, CA (US); Hongxu Yin, San Jose, CA (US); Huck Yang, Taipei City (TW); Jan Kautz, Lexington, MA (US); Frank Wang, Taipei City (TW)

(21) Appl. No.: 19/229,953

(22) Filed: Jun. 5, 2025

Related U.S. Application Data
(60) Provisional application No. 63/695,782, filed on Sep. 17, 2024.

(51) Int. Cl. G06N 3/0495

(52) U.S. Cl. CPC G06N 3/0495

(57) ABSTRACT

Large language models (LLMs) learn via machine learning to understand and generate human-like text, and thus are power when used for various language-based tasks, such as text summarization, translation, and content generation. However, to provide superior performance, the LLM is often of a considerable model size and requires high inference costs. To mitigate the size and execution costs of LLMs, methods have been developed to specifically compress LLMs. However, most existing methods either incur significant accuracy degradation compared to uncompressed models or have high training time, while their adaptability is often constrained by a limited range of hardware-supported compression formats. The present disclosure provides error compensation for a compressed LLM in a training free manner that provides flexibility for diverse performance needs.

### CLAIM OF PRIORITY

This application claims the benefit of U.S. Provisional Application No. 63/695,782 (Attorney Docket No. NVIDP1415+/24-TP-1199US01) titled “EIGENSPACE LOW-RANK COMPRESSED LLM,” filed Sep. 17, 2024, the entire contents of which is incorporated herein by reference.

### TECHNICAL FIELD

The present disclosure relates to compressed large language models (LLMs).

### BACKGROUND

LLMs are models that learn via machine learning to understand and generate human-like text. They can be configured to perform various language-based tasks, such as text summarization, translation, and content generation. Although LLMs exhibit superior performance across diverse applications, their empirical deployment remains challenging due to their considerable model size and high inference costs. To mitigate these challenges, model compression solutions have been proposed, including post-training compression and compression-aware training.

However, most existing compression methods either degrade the accuracy of the LLM output as compared to the uncompressed LLM, or have high training time. In addition, the adaptability of a compressed LLM is often constrained by a limited range of hardware-supported compression formats (e.g., 2:4 sparsity, ¾-bit quantization), making it difficult to address various user requirements for accuracy and efficiency. For example, if a user is willing to accept slightly increased inference latency to gain better accuracy, a strict 2:4 sparsity requirement on some graphics processing units (GPUs) or existing integer quantization kernels rules out any intermediate approach, such as 2.X:4 sparsity or INT.X-bit quantization, where X can be any arbitrary value.

There is a need for addressing these issues and/or other issues associated with the prior art. For example, there is a need to provide error compensation for a compressed LLM in a training free manner that provides flexibility for diverse performance needs (e.g., tasks, compression ratios).

### SUMMARY

A method, computer readable medium, and system are disclosed to provide error compensation for a compressed LLM. An importance score is computed for a plurality of elements within a compressed LLM. A pair of low-rank matrices that are configured to compensate for error in the compressed LLM are generated as a function of the importance score.

### BRIEF DESCRIPTION OF THE DRAWINGS

FIG. 1 illustrates a method to generate a pair of low-rank matrices that are configured to provide error compensation for a compressed LLM, in accordance with an embodiment.

FIG. 2 illustrates a method to generate a pair of low-rank matrices as a function of importance scores computed for the plurality of elements within the compressed LLM, in accordance with an embodiment.

FIG. 3 illustrates an LLM processing pipeline, in accordance with an embodiment.

FIG. 4 illustrates a pipeline for generating the pair of low-rank matrices of FIG. 3, in accordance with an embodiment.

FIG. 5 illustrates an implementation of the LLM processing pipeline of FIG. 3 in which a second low-rank matrix in the pair of low-rank matrices and the compressed LLM are fused together to share a same output, in accordance with an embodiment.

FIG. 6 illustrates a method to provide error compensation for a compressed LLM, in accordance with an embodiment.

FIG. 7A illustrates inference and/or training logic, according to at least one embodiment;

FIG. 7B illustrates inference and/or training logic, according to at least one embodiment.

FIG. 8 illustrates training and deployment of a neural network, according to at least one embodiment.

FIG. 9 illustrates an example data center system, according to at least one embodiment.

### DETAILED DESCRIPTION

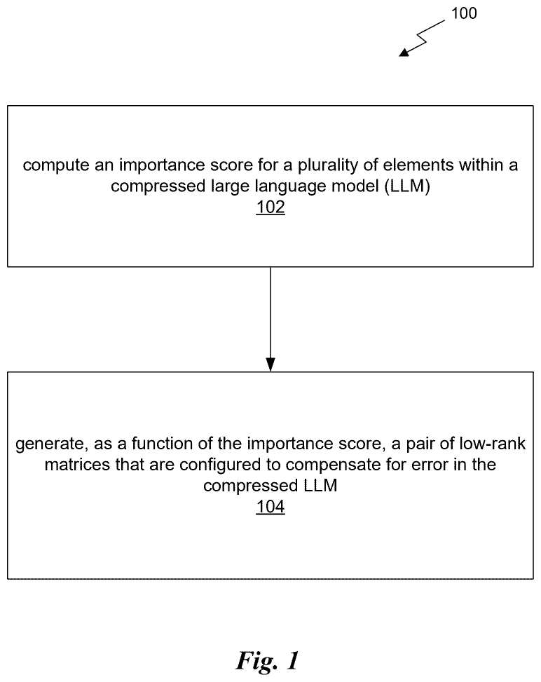

FIG. 1 illustrates a method 100 to generate a pair of low-rank matrices that are configured to provide error compensation for a compressed LLM, in accordance with an embodiment. The method 100 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

With respect to the present description, the compressed LLM refers to a LLM that has been compressed using one or more compression methods (e.g. compression processes, etc.). The LLM is a model that has learned via machine learning to perform at least one language-based task, such as generating a summarization of an input text, generating a translation of an input text, generating a new text for given text prompt, etc.

In an embodiment, the compressed LLM may be generated by quantizing the LLM.

Quantizing the LLM may include reducing a precision of the LLMs weights and/or activations. In an embodiment, the compressed LLM may be generated by pruning the LLM. Pruning the LLM may include removing portions of the LLM, such as individual weights, neurons, entire layers, etc.

In an embodiment, the compressed LLM may have a reduced size with respect to the (uncompressed) LLM. Thus, less memory may be required to store the compressed LLM than the LLM. In an embodiment, the compressed LLM may have reduced computations. In this embodiment, less processing resources may be required to execute the compressed LLM for inferencing than the LLM.

In any case, the compressed LLM exhibits one or more errors not present in the LLM. The errors may refer to a reduced accuracy in an output of the compressed LLM versus an output of the LLM. The errors may result from the compression method used to compress the LLM. As described herein, the present method 100 is performed to compensate for one or more errors of the compressed LLM.

In operation 102, an importance score is computed for a plurality of elements within the compressed LLM. In an embodiment, the plurality of elements may include weights of the compressed LLM. In an embodiment, the importance score may be computed for each of the plurality of elements within the compressed LLM.

In an embodiment, eigendecomposition may be performed to compute the importance score for the plurality of elements. Eigendecomposition refers to an operation that generates eigenvalues and eigenvectors from a given matrix. In the present embodiment, eigendecomposition may be performed on a matrix of the plurality of elements of the compressed LLM to compute the importance scores for the elements.

In an embodiment, the importance score may be computed per layer of the compressed LLM. For example, the importance score may be computed for each layer or for one or more layers of the compressed LLM. In an embodiment, the importance score may be computed per layer of the compressed LLM by projecting a compression error into an eigenspace of input activations of the layer, and using eigenvalues of each activation channel for the layer as the importance scores of the elements in the activation channel.

In an embodiment, the compression error may be projected into the eigenspace of the input activations of the layer by, for a given set of calibration data, performing eigendecomposition on average input activations of the layer to generate eigenvalues and eigenvectors, and projecting the compression error into the eigenspace with a projection matrix defined as a function of the eigenvalues and eigenvectors. In an embodiment, an eigenspace projection matrix derived from the eigendecomposition may include columns defining the eigenvectors, where a diagonal matrix derived from the eigendecomposition may include diagonal elements each being one of the eigenvalues of the eigenvectors, and where the projection matrix may be defined as a function of the eigenspace projection matrix and the diagonal matrix.

In operation 104, a pair of low-rank matrices that are configured to compensate for error in the compressed LLM are generated as a function of the importance score. With respect to the present description, the pair of low-rank matrices refer to residual low-rank paths that are configured to compensate for compression errors. Low-rank approximation may be used on an element (e.g. weight) matrix of the compressed LLM to generate the pair of low-rank matrices.

In an embodiment, a projected error may be obtained from projecting the compression error into the eigenspace, and the pair of low-rank matrices may be generated to minimize an error approximation loss computed from the projected error. In an embodiment, generating the pair of low-rank matrices as a function of the importance score computed for the plurality of elements within the compressed LLM may include allocating more low-rank representation capacity to approximate elements with higher importance scores than allocated to approximate elements with lower importance scores. In an embodiment, the pair of low-rank matrices may be generated in accordance with a requirement input by a user such that the pair of low-rank matrices compensate for the compressed LLM in a manner that is customized to the requirement. For example, the requirement may be a use of the compressed LLM for a specific task, a compression ratio that differs from a compression ratio of the compressed LLM, etc.

In an embodiment, the method 100 may further include deploying the compressed LLM with the pair of low-rank matrices. In an embodiment, the method 100 may further include processing an input in parallel through the compressed LLM to generate a first output and the pair of low-rank matrices to generate a second output, and aggregating the first output and the second output. In this embodiment, the second output may compensate for an error in the first output.

In another embodiment, the method 100 may further include using the pair of low-rank matrices to compensate for the compressed LLM by: processing an input through the compressed LLM to generate a first output, processing the input through the pair of low-rank matrices to generate a second output, and aggregating the second output with the first output to compensate for an error in the first output.

In an embodiment, a second low-rank matrix in the pair of low-rank matrices and the compressed LLM may be fused together to share a same output. This may reduce latency otherwise incurred as a result of the processing of the input through the low-rank residual paths represented by the pair of low-rank matrices, namely by using the shared memory to avoid the offloading and reloading of the output of the compressed LLM and low-rank residual paths to a cache and in turn reducing data transfer overhead.

Further embodiments will now be provided in the description of the subsequent figures. It should be noted that the embodiments disclosed herein with reference to the method 100 of FIG. 1 may apply to and/or be used in combination with any of the embodiments of the remaining figures below.

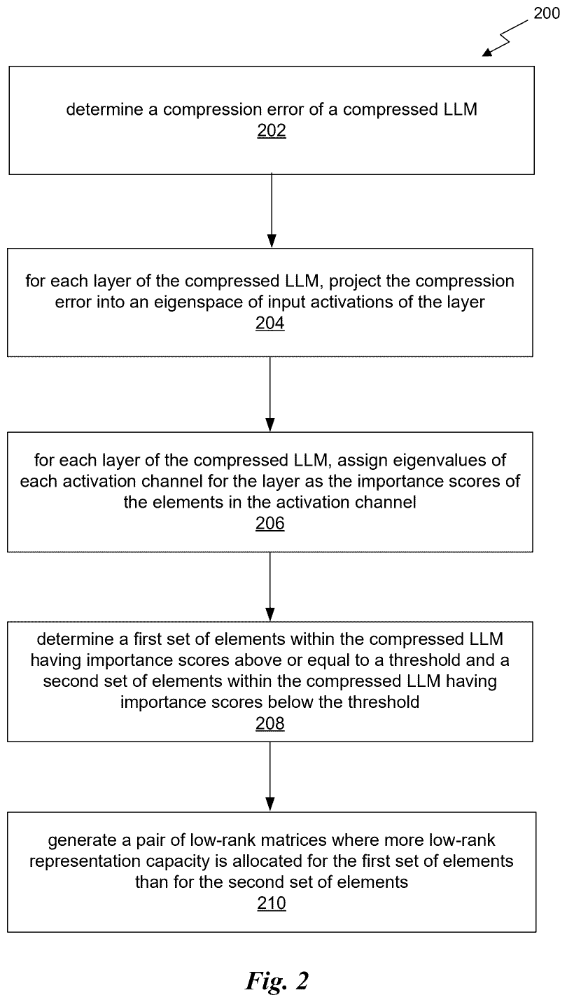

FIG. 2 illustrates a method 200 to generate a pair of low-rank matrices as a function of importance scores computed for the plurality of elements within the compressed LLM, in accordance with an embodiment. The method 200 may be one implementation of the method 100 of FIG. 1. Thus, the descriptions and/or definitions given above may equally apply to the present embodiment.

In operation 202, a compression error of a compressed LLM is determined. In an embodiment, the compression error may be determined by processing an input through the compressed LLM to generate a first result, processing the input through the (uncompressed) LLM to generate a second result, and computing a difference between the first result and the second result.

In operation 204, for each layer of the compressed LLM, the compression error is projected into an eigenspace of input activations of the layer. This may include, for a given set of calibration data, performing eigendecomposition on average input activations of the layer to generate eigenvalues and eigenvectors, and projecting the compression error into the eigenspace with a projection matrix defined as a function of the eigenvalues and eigenvectors. An eigenspace projection matrix derived from the eigendecomposition may include columns defining the eigenvectors, and a diagonal matrix derived from the eigendecomposition may include diagonal elements that are each one of the eigenvalues of the eigenvectors. In this embodiment, the projection matrix may be defined as a function of the eigenspace projection matrix and the diagonal matrix.

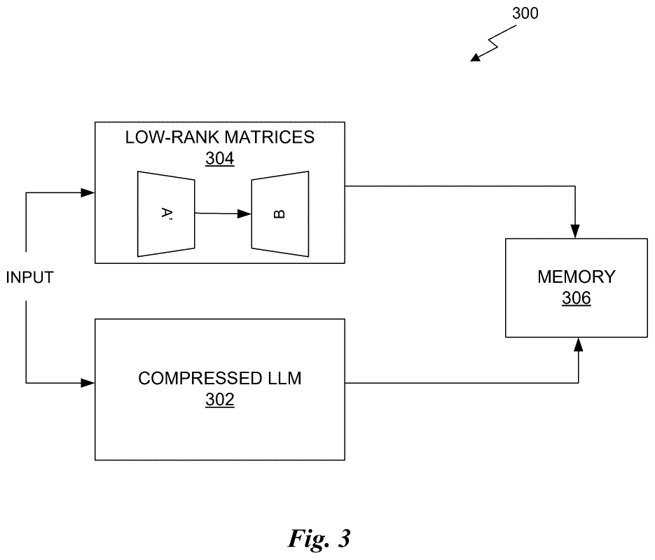

In operation 206, for each layer of the compressed LLM, eigenvalues of each activation channel for the layer are assigned as the importance scores of the elements in the activation channel. In operation 208, a first set of elements within the compressed LLM having importance scores above or equal to a threshold are determined and a second set of elements within the compressed LLM having importance scores below the threshold are determined. In operation 210, a pair of low-rank matrices is generated, where more low-rank representation capacity is allocated for the first set of elements than for the second set of elements. In the present embodiment, the pair of low-rank matrices are configured to compensate for error in the compressed LLM. The pair of low-rank matrices may then be deployed with the compressed LLM for use in compensating for error introduced in output of the compressed LLM, as described in detail below with reference to FIG. 3.

FIG. 3 illustrates an LLM processing pipeline 300, in accordance with an embodiment. As shown, an input is processed (in parallel) through a compressed LLM 302 and a pair of low-rank matrices 304 to generate respective outputs. The outputs are stored to a memory 306 that is shared by the compressed LLM 302 and the low-rank matrices 304. The outputs are aggregated, such that the output of the pair of low-rank matrices 304 provides compensation for an error in the output of the compressed LLM 302.

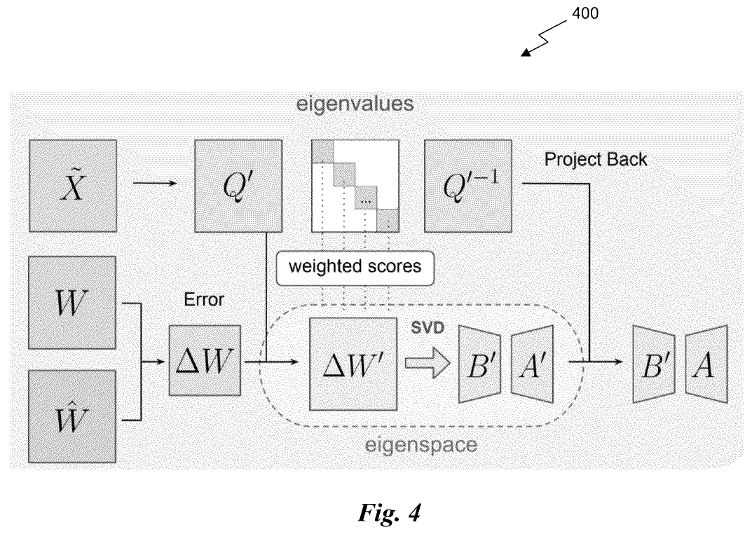

FIG. 4 illustrates a pipeline 400 for generating the pair of low-rank matrices of FIG. 3, in accordance with an embodiment.

Post-training compression aims to compress a well-optimized model by a targeted compression ratio utilizing only a limited set of calibration data. The compression process is often framed as a layer-wise optimization problem, aiming to minimize the layer-wise output difference between the original weight Ŵₗ∈ [symbol] ^{d×k} or each layer l. Then the layer-wise model compression loss can be formed per Equation 1.

$$\begin{matrix}arg min \\ {\hat{W}}_{l}\end{matrix} {‖ {W}_{l} {X}_{l} - {\hat{W}}_{l} {X}_{l} ‖}_{F} \qquad \underline{Equation 1}$$

where Xₗ∈ [symbol] ^{d×k} is the input activation of layer l and F denotes the Frobenius error between the layer-wise output. Once the compression is complete, the Wₗ for each layer will be substituted with Ŵₗ, resulting in a smaller model size, faster inference, or both. However, their flexibility is often limited by a discrete set of compression formats (e.g., 2:4 sparsity, ¾-bit quantization), making it challenging to meet the diverse capacity and efficiency requirements of different users.

To remove the constraint by specific compression formats, the conventional model compression problem is re-formulated into a customized compensation problem: Given a compressed model, residual low-rank paths are introduced to compensate for compression errors under customized requirements from users, such as tasks, compression ratios, etc. With these residual paths, the compensated model gains greater flexibility in adjusting overall capacity. To derive the low-rank residual paths that can represent compression errors, one existing naive method is directly adopting Singular Value Decomposition (SVD). More specifically, this method relies on a closed-form solution by using SVD to approximate the compression error

$$Δ {W}_{l} = {W}_{l} - {\hat{W}}_{l} as Δ {W}_{l} = {U}_{l} {\sum }_{l} {V}_{l}^{T} ,$$

where Σₗ∈ [symbol] ^{r×r} is a diagonal matrix containing the top-r largest singular value sorted in descending order, and Uₗ∈ [symbol] ^{d×r}, Vₗ∈ [symbol] ^{k×r} are orthonormal matrices, with each column representing the singular vectors corresponding to the singular values in Σₗ. The product of Uₗ and Uₗ can then be treated as Bₗ=UₗΣₗ with

$${V}_{l}^{T}$$

being treated as Aₗ. Overall, the error approximation loss can be formulated per Equation 2.

$$\begin{matrix}arg min \\ {B}_{t} , {A}_{t}\end{matrix} {‖ Δ {W}_{l} - {B}_{l} {A}_{l} ‖}_{2} \qquad \underline{Equation 2}$$

where SVD is applied on ΔWₜ to minimize the above equation. However, naively applying SVD to optimize error approximation loss, per Equation 2, does not guarantee the minimization of layer-wise compression loss, per Equation 1, and fails to account for the varying importance of individual model weights, resulting in suboptimal utilization of the low-rank representation capacity.

In the remaining description, the subscript, which corresponds to layer l, is omitted for simplicity.

Compared with standard model compression methods, model compensation introduces residual low-rank paths to compensate for compression errors, resulting in greater flexibility in adjusting overall capacity without being constrained by specific compression formats. However, existing methods rely mainly on plain SVD for low-rank approximation, as described above, lacking sufficient representation capacity to fully approximate ΔW. In other words, the target rank r remains significantly smaller than the intrinsic rank of ΔW. Therefore, it is desirable to allocate the limited representation capacity of r more effectively, focusing on reconstructing the more important weights while placing less emphasis on less important segments.

Moreover, naive SVD performs the approximation in the original space, failing to ensure that minimizing the approximation error, per Equation 2, directly leads to minimizing the layer-wise compression loss, per Equation 1. Furthermore, current approaches either offer limited compensation performance by neglecting calibration data or lose flexibility due to the high computational cost of compression-aware fine-tuning, making it difficult to swiftly adjust to various tasks.

The present pipeline 400 proposes Training-free Eigenspace Low-Rank Approximation (EoRA), which retains the flexibility advantages of model compensation while enhancing both efficiency and effectiveness compared to existing approaches. First, the compression error is projected into the eigenspace of the corresponding layer's input activations, ensuring a direct relationship between the error approximation loss and the overall layer-wise model compression loss. In accordance with the classical Principal Component Analysis (PCA) algorithm, the eigenvalues of each activation channel are leveraged as importance scores to indicate the importance of each column after the eigenprojection. This allows more low-rank representation capacity to be allocated for approximating the more critical error elements. Following PCA, the eigendecomposition is performed on \tilde{X}\tilde{X}^{T} where \tilde{X}∈ [symbol] ^{k×n} is the average of the input activations over the calibration set. The decomposition \tilde{X}\tilde{X}^{T}=QΛQ^{T} is then used to derive the eigenspace projection matrix Q∈ [symbol] ^{k×k} whose columns are the eigenvectors and Λ∈ [symbol] ^{k×k} which is a diagonal matrix with each diagonal element being the corresponding eigenvalues of the eigenvectors in Q. The compression error ΔW is then projected into eigenspace with the projection matrix Q′=Q\sqrt{Λ} to obtain the projected error ΔW′∈ [symbol] ^{d×k}=ΔWQ″. The proposed new error approximation loss, EoRA loss, can be formulated per Equation 3.

$$\begin{matrix}arg min \\ {B}^{′} , {A}^{′}\end{matrix} {‖ Δ {W}_{l} - {B}^{′} {A}^{′} ‖}_{2} \qquad \underline{Equation 3}$$

where SVD is applied on ΔW′ to minimize the above equation and B′ and A′ denote the corresponding solutions in the eigenspace. This loss function ensures that error columns associated with larger eigenvalues are approximated more accurately than those with smaller eigenvalues, thereby facilitating a more effective allocation of the insufficient low-rank expressive power. Since Q is an orthogonal matrix, the low-rank approximated ΔW′ can be multiplied with Q′⁻¹=\sqrt{Λ}⁻¹ Q^{T} to project back to the original space after the layer-wise reconstruction, obtaining the reconstructed error ΔW=ΔW′Q′⁻¹ approximated by B′A′Q′⁻¹. The product of A′ and Q′⁻¹ can be consolidated into a single matrix with the same dimensions as the original A′, ensuring no additional inference latency as A=A′Q′⁻¹. Then, the forward pass of the compressed model compensated with EoRA for the input activation X can be formulated per Equation 4.

$$\hat{W} X + {B}^{′} AX \qquad \underline{Equation 4}$$

The overall training-free optimization of Equation 3 in EoRA can be done in minutes using only a small amount of calibration data without any gradient computation. EoRA can also provide better initialization for fine-tuning to further enhance accuracy and offer a trade-off between accuracy and training time. Moreover, EoRA is robust to quantization which can further reduce the additional cost of residual low-rank compensation paths.

The overall eigenspace projection method, as depicted in FIG. 4, may be implemented per Algorithm 1.

Algorithm 1

Input: \tilde{X}: Average of the input activations of the current
layer over the calibration
set, W: Full-precision Weight, Ŵ: Compressed Weight,
r: Compensation rank
Output: B′,A: Two low-rank matrices for compensation.
1. ΔW = W − Ŵ
2. Run Eigendecompostion on \tilde{X}\tilde{X}^{T} = QΛQ^{T}
3. Reformulate QΛQ^{T} = (Q\sqrt{Λ})(\sqrt{Λ}Q^{T}) = Q′Q′^{T}
4. Project the compression error to eigenspace ΔW′ = ΔWQ′
5. Run r-rank SVD approximation on ΔW, B′A′ = U′Σ′V′ = SVD(ΔW′)
6. Project the approximation back to the original space A = A′Q′⁻¹
7. The final forward pass of current layer becomes Ŵ X + B′AX

Mapping EoRA loss (Equation 3) to compression loss (Equation 1): The goal of low-rank compensation is to approximate=ΔW such that the approximation also minimize Equation 1. To achieve this, the compression objective for each layer is reformulated per Equation 5.

$$\begin{matrix}arg min \\ B , A\end{matrix} {‖ WX - ( W + BA ) X ‖}_{F} = \begin{matrix}arg min \\ B , A\end{matrix} {‖ Δ WX - BAX ‖}_{F} \qquad \underline{Equation 5}$$

Since the Frobenius norm of a matrix is equal to the square root of its gram matrix, the minimization problem can be rewritten per Equation 6.

$$\begin{matrix}arg min \\ B , A\end{matrix} {‖ Δ WX - BAX ‖}_{F} = {\begin{matrix}arg min [ trace ( ( Δ WX - BA ) {{XX}^{T} ( Δ W - BA )}^{T} ‖ \\ B , A\end{matrix}}^{\frac{1}{2}} \qquad \underline{Equation 6}$$

Directly applying SVD on ΔW initially does not guarantee the minimization of the above Equation 6, as dropping the smallest singular values does not necessarily lead to the smallest layer-wise compression error (Equation 6) compared to discarding other singular values. To address this issue, EoRA projects ΔW into the eigenspace before performing SVD.

Fine-Tuning Compressed Models with EoRA

In an embodiment, EoRA can be fine-tuned to further recover the accuracy loss of the compressed model. In this embodiment, the compressed model may be frozen while tuning the low-rank residual components during fine-tuning.

### Kernel Optimization and Inference Speed Evaluation

In embodiments, compensating a compressed model with low-rank residual paths may lead to a noticeable increase in latency, primarily because input and output must transfer between L2 cache and dynamic random access memory (DRAM) twice as often compared to that without a low-rank residual path, shifting the inference process from being computation-bound to memory-bound.

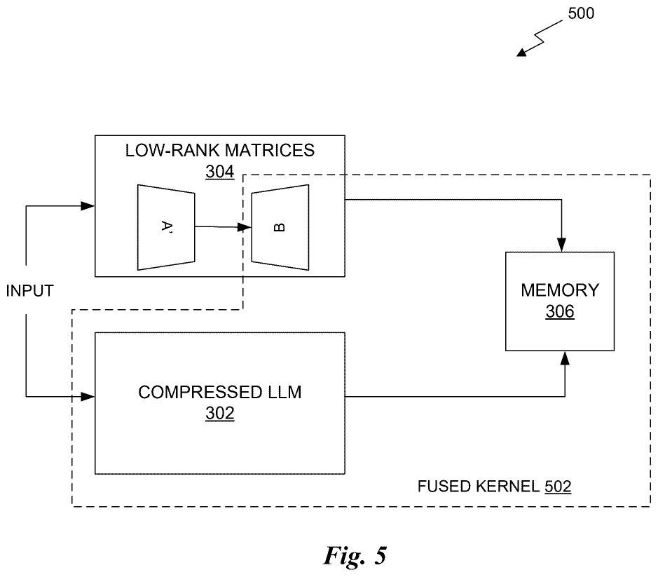

To address this, the compressed LLM 302 and the second low-rank matrix (B) of the pair of low rank-matrices 304 may be fused together, forming a fused kernel 502 that shares the same memory 306, as illustrated in FIG. 5. More specifically, the low-bit weight quantization kernel representing the compressed LLM may be fused with the matrix multiplication of B, which shares the same output. By doing so, the shared output no longer needs to be offloaded and reloaded to the L2 cache, effectively reducing data transfer overhead.

In language generation, the model produces tokens sequentially, making matrix-vector multiplications the primary factor impacting the inference latency. Consequently, the EoRA kernel may be built on top of GPTQ's low-bit quantized matrix vector product kernel, pre-allocating the shared output prior to matrix vector multiplication and integrating the full-precision matrix vector multiplication of B into the quantized kernel reducing redundant memory access.

### Quantization of EoRA

EoRA can also be quantized to further reduce the additional cost of residual low-rank compensation paths. In an embodiment, EoRA may be robust to quantization, which means that when EoRA is quantized, the accuracy drop from full-precision EoRA is insignificant while the model size is significantly reduced.

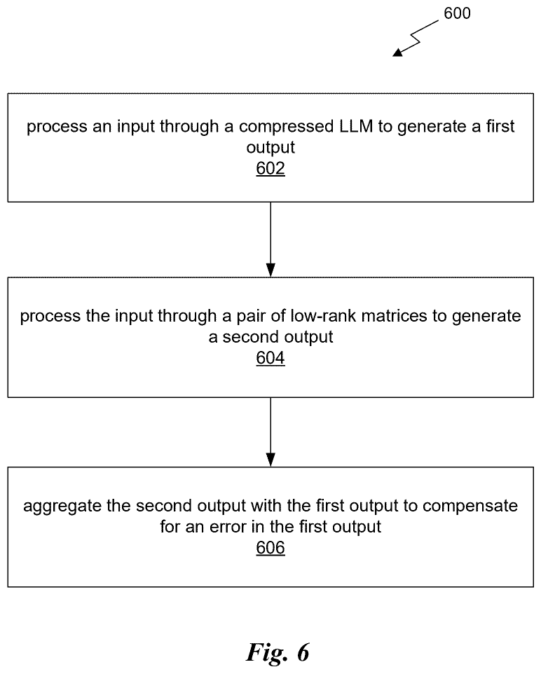

FIG. 6 illustrates a method 600 to provide error compensation for a compressed LLM, in accordance with an embodiment. The method 600 may be performed using the LLM processing pipeline 300 of FIG. 3, in an embodiment.

In operation 602, an input is processed through a compressed LLM to generate a first output. In operation 604, the input is processed through a pair of low-rank matrices to generate a second output. In operation 606, the second output is aggregated with the first output to compensate for an error in the first output. In an embodiment, a result of the aggregation may be output to a memory. In an embodiment, a result of the aggregation may be output to a downstream task or application for further processing.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

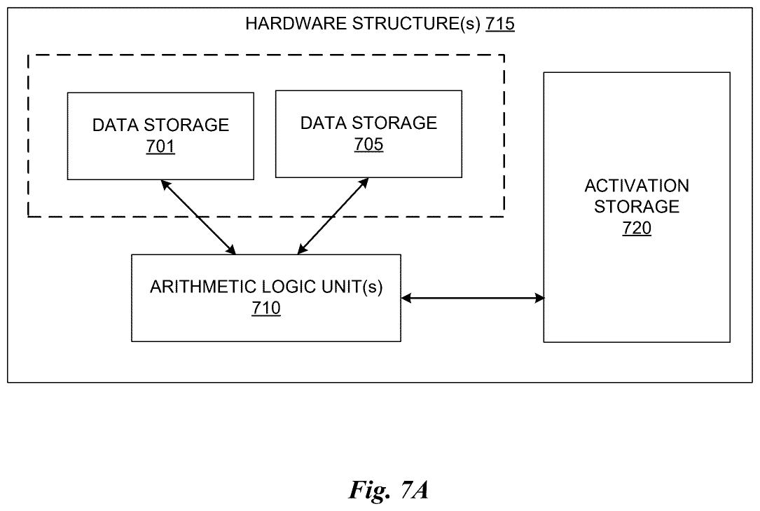

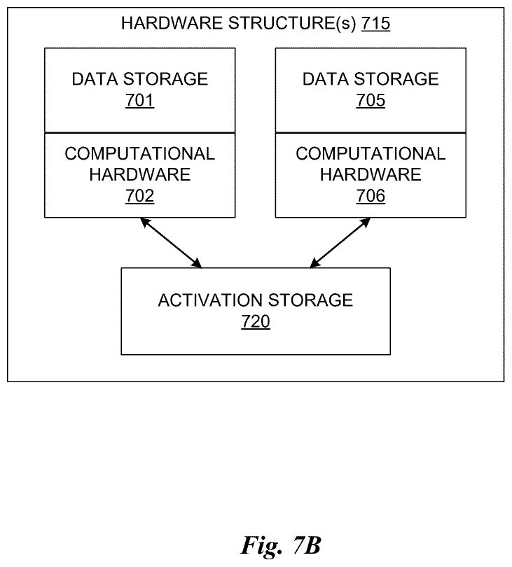

As noted above, a deep learning or neural learning system needs to be trained to generate inferences from input data. Details regarding inference and/or training logic 715 for a deep learning or neural learning system are provided below in conjunction with FIGS. 7A and/or 7B.

In at least one embodiment, inference and/or training logic 715 may include, without limitation, a data storage 701 to store forward and/or output weight and/or input/output data corresponding to neurons or layers of a neural network trained and/or used for inferencing in aspects of one or more embodiments. In at least one embodiment data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 701 may be included with other on-chip or off-chip data storage, including a processor's L1, L2, or L3 cache or system memory.

In at least one embodiment, any portion of data storage 701 may be internal or external to one or more processors or other hardware logic devices or circuits. In at least one embodiment, data storage 701 may be cache memory, dynamic randomly addressable memory (“DRAM”), static randomly addressable memory (“SRAM”), non-volatile memory (e.g., Flash memory), or other storage. In at least one embodiment, choice of whether data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a data storage 705 to store backward and/or output weight and/or input/output data corresponding to neurons or layers of a neural network trained and/or used for inferencing in aspects of one or more embodiments. In at least one embodiment, data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 705 may be included with other on-chip or off-chip data storage, including a processor's L1, L2, or L3 cache or system memory. In at least one embodiment, any portion of data storage 705 may be internal or external to on one or more processors or other hardware logic devices or circuits. In at least one embodiment, data storage 705 may be cache memory, DRAM, SRAM, non-volatile memory (e.g., Flash memory), or other storage. In at least one embodiment, choice of whether data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 701 and data storage 705 may be separate storage structures. In at least one embodiment, data storage 701 and data storage 705 may be same storage structure. In at least one embodiment, data storage 701 and data storage 705 may be partially same storage structure and partially separate storage structures. In at least one embodiment, any portion of data storage 701 and data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710 to perform logical and/or mathematical operations based, at least in part on, or indicated by, training and/or inference code, result of which may result in activations (e.g., output values from layers or neurons within a neural network) stored in an activation storage 720 that are functions of input/output and/or weight parameter data stored in data storage 701 and/or data storage 705. In at least one embodiment, activations stored in activation storage 720 are generated according to linear algebraic and or matrix-based mathematics performed by ALU(s) 710 in response to performing instructions or other code, wherein weight values stored in data storage 705 and/or data 701 are used as operands along with other values, such as bias values, gradient information, momentum values, or other parameters or hyperparameters, any or all of which may be stored in data storage 705 or data storage 701 or another storage on or off-chip. In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 701, data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, data storage 701 and data storage 705, which may be used to store weight values and/or other information, including bias values, gradient information, momentum values, and/or other parameter or hyperparameter information. In at least one embodiment illustrated in FIG. 7B, each of data storage 701 and data storage 705 is associated with a dedicated computational resource, such as computational hardware 702 and computational hardware 706, respectively. In at least one embodiment, each of computational hardware 706 comprises one or more ALUs that perform mathematical functions, such as linear algebraic functions, only on information stored in data storage 701 and data storage 705, respectively, result of which is stored in activation storage 720.

In at least one embodiment, each of data storage 701 and 705 and corresponding computational hardware 702 and 706, respectively, correspond to different layers of a neural network, such that resulting activation from one “storage/computational pair 701/702” of data storage 701 and computational hardware 702 is provided as an input to next “storage/computational pair 705/706” of data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Neural Network Training and Deployment

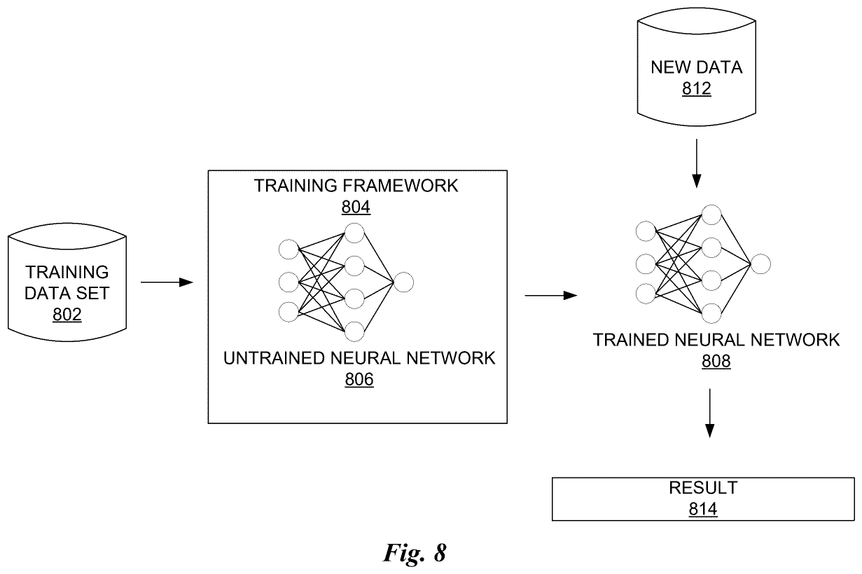

FIG. 8 illustrates another embodiment for training and deployment of a deep neural network. In at least one embodiment, untrained neural network 806 is trained using a training dataset 802. In at least one embodiment, training framework 804 is a PyTorch framework, whereas in other embodiments, training framework 804 is a Tensorflow, Boost, Caffe, Microsoft Cognitive Toolkit/CNTK, MXNet, Chainer, Keras, Deeplearning4j, or other training framework. In at least one embodiment training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having known output and the output of the neural network is manually graded. In at least one embodiment, untrained neural network 806 is trained in a supervised manner processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on known input data, such as new data 812. In at least one embodiment, training framework 804 trains untrained neural network 806 repeatedly while adjust weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map, which is a type of trained neural network 808 capable of performing operations useful in reducing dimensionality of new data 812. In at least one embodiment, unsupervised training can also be used to perform anomaly detection, which allows identification of data points in a new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new data 812 without forgetting knowledge instilled within network during initial training.

### Data Center

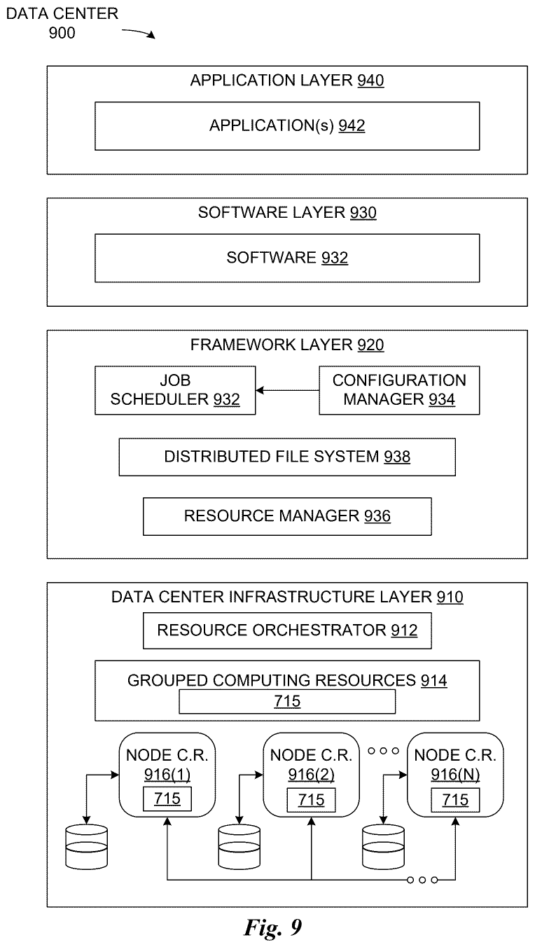

FIG. 9 illustrates an example data center 900, in which at least one embodiment may be used. In at least one embodiment, data center 900 includes a data center infrastructure layer 910, a framework layer 920, a software layer 930 and an application layer 940.

In at least one embodiment, as shown in FIG. 9, data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 916(1)-916(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 922 may configure or otherwise control one or more node C.R.s 916(1)-916(N) and/or grouped computing resources 914. In at least one embodiment, resource orchestrator 922 may include a software design infrastructure (“SDI”) management entity for data center 900. In at least one embodiment, resource orchestrator may include hardware, software or some combination thereof.

In at least one embodiment, as shown in FIG. 9, framework layer 920 includes a job scheduler 932, a configuration manager 934, a resource manager 936 and a distributed file system 938. In at least one embodiment, framework layer 920 may include a framework to support software 932 of software layer 930 and/or one or more application(s) 942 of application layer 940. In at least one embodiment, software 932 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 932 may include a Spark driver to facilitate scheduling of workloads supported by various layers of data center 900. In at least one embodiment, configuration manager 934 may be capable of configuring different layers such as software layer 930 and framework layer 920 including Spark and distributed file system 938 for supporting large-scale data processing. In at least one embodiment, resource manager 936 may be capable of managing clustered or grouped computing resources mapped to or allocated for support of distributed file system 938 and job scheduler 932. In at least one embodiment, clustered or grouped computing resources may include grouped computing resource 914 at data center infrastructure layer 910. In at least one embodiment, resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. one or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, data center 900 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 900. In at least one embodiment, trained machine learning models corresponding to one or more neural networks may be used to infer or predict information using resources described above with respect to data center 900 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

As described herein, a method, computer readable medium, and system are disclosed to provide error compensation for a compressed LLM. In accordance with FIGS. 1-6, embodiments may provide a compressed LLM with low-rank matrices usable for performing inferencing operations and for providing inferenced data. The LLM with low-rank matrices may be stored (partially or wholly) in one or both of data storage 701 and 705 in inference and/or training logic 715 as depicted in FIGS. 7A and 7B. Training and deployment of the LLM with low-rank matrices may be performed as depicted in FIG. 8 and described herein. Distribution of the LLM with low-rank matrices may be performed using one or more servers in a data center 900 as depicted in FIG. 9 and described herein.

What is claimed is:

1. A method, comprising:
at a device:
computing an importance score for a plurality of elements within a compressed large language model (LLM);
generating, as a function of the importance score, a pair of low-rank matrices that are configured to compensate for an error in the compressed LLM;
using the pair of low-rank matrices to compensate for the compressed LLM by:
processing an input through the compressed LLM to generate a first output,
processing the input through the pair of low-rank matrices to generate a second output, and
aggregating the second output with the first output to compensate for an error in the first output.

2. The method of claim 1, wherein the compressed LLM is generated by at least one of quantizing the LLM or pruning the LLM.

3. The method of claim 1, wherein the plurality of elements include weights of the compressed LLM.

4. The method of claim 1, wherein eigendecomposition is performed to compute the importance score for the plurality of elements.

5. The method of claim 1, wherein the importance score is computed per layer of the compressed LLM by:
projecting a compression error into an eigenspace of input activations of the layer, and
using eigenvalues of each activation channel for the layer as the importance scores of the elements in the activation channel.

6. The method of claim 5, wherein the compression error is projected into the eigenspace of the input activations of the layer by:
for a given set of calibration data, performing eigendecomposition on average input activations of the layer to generate eigenvalues and eigenvectors, and
projecting the compression error into the eigenspace with a projection matrix defined as a function of the eigenvalues and eigenvectors.

7. The method of claim 6, wherein an eigenspace projection matrix derived from the eigendecomposition includes columns defining the eigenvectors, and wherein a diagonal matrix derived from the eigendecomposition includes diagonal elements each being one of the eigenvalues of the eigenvectors, and wherein the projection matrix is defined as a function of the eigenspace projection matrix and the diagonal matrix.

8. The method of claim 6, wherein a projected error is obtained from projecting the compression error into the eigenspace, and wherein the pair of low-rank matrices are generated to minimize an error approximation loss computed from the projected error.

9. The method of claim 1, wherein generating the pair of low-rank matrices as a function of the importance score computed for the plurality of elements within the compressed LLM includes allocating more low-rank representation capacity to approximate elements with higher importance scores than allocated to approximate elements with lower importance scores.

10. The method of claim 1, wherein the pair of low-rank matrices are generated in accordance with a requirement input by a user such that the pair of low-rank matrices compensate for the compressed LLM in a manner that is customized to the requirement.

11. The method of claim 10, wherein the requirement is a use of the compressed LLM for a specific task.

12. The method of claim 10, wherein the requirement is a compression ratio that differs from a compression ratio of the compressed LLM.

13. The method of claim 1, wherein a second low-rank matrix in the pair of low-rank matrices and the compressed LLM are fused together to share a same output.

14. A system, comprising:
a non-transitory memory comprising instructions; and
one or more processors in communication with the non-transitory memory, wherein the one or more processors execute the instructions to:
compute an importance score for a plurality of elements within a compressed large language model (LLM); and
generate, as a function of the importance score, a pair of low-rank matrices that are configured to compensate for an error in the compressed LLM.

15. The system of claim 14, wherein the plurality of elements include weights of the compressed LLM.

16. The system of claim 14, wherein the importance score is computed per layer of the compressed LLM by:
projecting a compression error into an eigenspace of input activations of the layer, and
using eigenvalues of each activation channel for the layer as the importance scores of the elements in the activation channel.

17. The system of claim 14, wherein generating the pair of low-rank matrices as a function of the importance score computed for the plurality of elements within the compressed LLM includes allocating more low-rank representation capacity to approximate elements with higher importance scores than allocated to approximate elements with lower importance scores.

18. The system of claim 14, wherein the one or more processors further execute the instructions to:
deploy the compressed LLM with the pair of low-rank matrices.

19. The system of claim 18, wherein the one or more processors further execute the instructions to:
process an input in parallel through the compressed LLM to generate a first output and the pair of low-rank matrices to generate a second output, and
aggregate the first output and the second output.

20. The system of claim 19, wherein the second output compensates for an error in the first output.

21. The system of claim 18, wherein a second low-rank matrix in the pair of low-rank matrices and the compressed LLM are fused together to share a same output.

22. A non-transitory computer-readable media storing computer instructions which when executed by one or more processors of a device cause the device to:
compute an importance score for a plurality of elements within a compressed large language model (LLM); and
generate, as a function of the importance score, a pair of low-rank matrices that are configured to compensate for an error in the compressed LLM.

23. The non-transitory computer-readable media of claim 22, wherein the plurality of elements include weights of the compressed LLM.

24. The non-transitory computer-readable media of claim 22, wherein the importance score is computed per layer of the compressed LLM by:
projecting a compression error into an eigenspace of input activations of the layer, and
using eigenvalues of each activation channel for the layer as the importance scores of the elements in the activation channel.

25. The non-transitory computer-readable media of claim 22, wherein generating the pair of low-rank matrices as a function of the importance score computed for the plurality of elements within the compressed LLM includes allocating more low-rank representation capacity to approximate elements with higher importance scores than allocated to approximate elements with lower importance scores.

26. The non-transitory computer-readable media of claim 22, wherein the device is further caused to:
deploy the compressed LLM with the pair of low-rank matrices;
process an input in parallel through the compressed LLM to generate a first output and the pair of low-rank matrices to generate a second output; and
aggregate the first output and the second output, wherein the second output compensates for an error in the first output.

27. The non-transitory computer-readable media of claim 22, wherein the device is further caused to:
process an input in parallel through the compressed LLM to generate a first output and the pair of low-rank matrices to generate a second output, and
aggregate the first output and the second output, wherein the second output compensates for an error in the first output.

28. The non-transitory computer-readable media of claim 27, wherein a second low-rank matrix in the pair of low-rank matrices and the compressed LLM are fused together to share a same output.
